(19) United States
(12) Patent Application Publication
(10) Pub. No.: US 2025/0357514 A1
(43) Pub. Date: Nov. 20, 2025

(54) UNIFORM DISTRIBUTION OF SHUNT CURRENTS IN FLOW BATTERY

(71) Applicant: LOCKHEED MARTIN ENERGY, LLC, Grand Prairie, TX (US)

(72) Inventors: Kevin Hartley BEVERAGE, Sterling, MA (US); Jeremy S. LORETZ, Waltham, MA (US); Adam J. MORRIS-COHEN, Cambridge, MA (US)

(21) Appl. No.: 18/862,740

(22) PCT Filed: May 9, 2023
(86) PCT No.: PCT/US2023/066754

§ 371 Date: Nov. 4, 2024

Related U.S. Application Data
(60) Provisional application No. 63/339,720, filed on May 9, 2022.

(51) Int. Cl. H01M 8/04858; H01M 8/04746; H01M 8/18; H01M 8/2455; H01M 8/2484

(52) U.S. Cl. CPC H01M 8/0491; H01M 8/04746; H01M 8/04873; H01M 8/188; H01M 8/2455; H01M 8/2484

(57) ABSTRACT

A flow battery system is disclosed.

### CROSS-REFERENCE TO RELATED APPLICATIONS

The present application claims priority to and the benefit of U.S. patent application No. 63/339,720, “Uniform Distribution Of Shunt Currents In Flow Battery” (filed May 9, 2022). All foregoing applications are incorporated herein by reference in their entireties for any and all purposes.

### TECHNICAL FIELD

The present disclosure relates generally to a fluid battery system and method, and more particularly, to a configuration and control of the flow battery system to fully discharge and de-energize all of a plurality of cells of the flow battery system.

### BACKGROUND

An electrochemical cell of a flow battery includes a cathode side and anode side separated by a separator arrangement. The cathode side can include a cathode current collector, a cathode electroactive material and an electrolyte. The anode side can include an anode current collector, an anode electroactive material and an electrolyte. The separator arrangement separating the cathode and anode sides, permits ionic flow therebetween. The current collectors, electroactive materials, electrolytes and separator arrangement thus form an electrochemical reactor that converts chemical energy to electricity. The current collectors can be electrically connected together to form an electrical circuit.

The information included in this Background section of the specification, including any references cited herein and any description or discussion thereof, is included for technical reference purposes only and is not to be regarded subject matter by which the scope of the invention is to be bound.

### SUMMARY

An aspect of the present disclosure provides a flow battery system. The flow battery system comprises a plurality of cells, a positive manifold, a negative manifold, a first electrode, and a second electrode. Each of the plurality of cells includes a positive flow channel configured to receive a positive electrolyte and a negative flow channel configured to receive a negative electrolyte. The plurality of cells are arranged in series from a first cell of the plurality of cells to a second cell of the plurality of cells. The positive manifold is configured to supply the positive electrolyte to the positive flow channel. The negative manifold is configured to supply the negative electrolyte to the negative flow channel. The first electrode is connected between the negative flow channel of the first cell and a load. The first electrode is selectively connected between the negative flow channel of the first cell and the negative manifold, such that when the first electrode is connected to the negative manifold a current is free to flow between the first electrode and the negative manifold, and when the first electrode is disconnected from the negative manifold the current is substantially prevented from flowing between the first electrode and the negative manifold. The second electrode is connected between the positive flow channel of the second cell and the load.

Another aspect of the present disclosure provides a method for operating a flow battery system. The flow battery system including a plurality of cells that each have a positive flow channel for receiving a positive electrolyte and a negative flow channel for receiving a negative electrolyte. The plurality of cells being arranged in series from a first cell of the plurality of cells to a second cell of the plurality of cells. The method comprises: ceasing a flow of the negative electrolyte from a negative manifold to the negative flow channel; ceasing a flow of the positive electrolyte from a positive manifold to the positive flow channel; and connecting a first electrode between the negative flow channel of the first cell and the negative manifold such that a current is free to flow between the first electrode and the negative manifold, wherein the first electrode is connected between the negative flow channel of the first cell and the load, and wherein a second electrode is connected between the positive flow channel and the load.

Another aspect of the present disclosure provides a flow battery system. The flow battery system comprises a plurality of cells, a positive manifold, a negative manifold, a first electrode, and a second electrode. Each of the plurality of cells includes a positive flow channel for receiving a positive electrolyte and a negative flow channel for receiving a negative electrolyte. The plurality of cells are arranged in series from a first cell of the plurality of cells to a second cell of the plurality of cells. The positive manifold is configured to supply the positive electrolyte to the positive flow channel. The negative manifold is configured to supply the negative electrolyte to the negative flow channel. The first electrode is connected between the negative flow channel of the first cell and a load. The first electrode is selectively connected between the negative flow channel of the first cell and the negative manifold, and wherein the first electrode is further selectively connected between the negative flow channel of the first cell and the positive manifold. The second electrode is connected between the positive flow channel of the second cell and the load. The second electrode is selectively connected between the positive flow channel of the second cell and the positive manifold, and wherein the second electrode is further selectively connected between the positive flow channel of the second cell and the negative manifold.

This summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

FIG. 1 illustrates a graph of shunt current versus cell position for a conventional flow battery system.

FIG. 2 illustrates a graph of shunt current versus cell position for a conventional flow battery system compared to a graph of shunt current versus cell position for a flow battery system according to an aspect of this disclosure.

FIG. 3 illustrates a schematic of a flow battery system, according to an aspect of this disclosure.

FIG. 4 illustrates a schematic of a flow battery stack of the flow battery system shown in FIG. 3, according to an aspect of this disclosure.

FIG. 5 illustrates a schematic of a circuit for the battery stack shown in FIG. 4, according to an aspect of this disclosure.

### DETAILED DESCRIPTION

Certain terminology used in this description is for convenience only and is not limiting. The words “top”, “bottom”, “leading”, “trailing”, “above”, “below”, “axial”, “transverse”, “circumferential,” and “radial” designate directions in the drawings to which reference is made. The term “substantially” is intended to mean considerable in extent or largely but not necessarily wholly that which is specified. All ranges disclosed herein are inclusive of the recited endpoint and independently combinable (for example, the range of “from 2 grams to 10 grams” is inclusive of the endpoints, 2 grams and 10 grams, and all the intermediate values). The terminology includes the above-listed words, derivatives thereof and words of similar import.

A flow battery stack has induced self-discharge currents that result from a network of battery cells (e.g. a plurality of cells) and conductive electrolyte paths within a battery stack. The distribution of current is such that the center cells of a stack have the highest magnitude of current and the end cells have very low to zero current. During a shutdown, this can result in the center cells becoming starved of active material and leading to gas generation or electrolyte degradation.

In conventional flow battery systems that have parallel fluid connections, a non-uniform magnitude of the shunt currents can lead to starvation in some battery cells, generating gas, changing pH, and potentially degrading active material. A “pumps off” shutdown is a worst case for conventional flow battery systems.

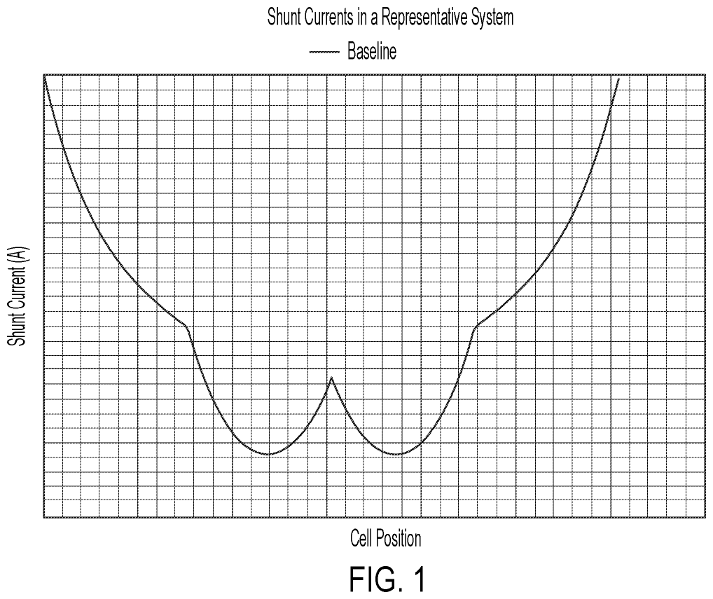

FIG. 1 illustrates an example of a plot of shunt currents versus battery cell position in a conventional flow battery system. The flow battery system in this example includes 4 battery stacks that each include a plurality of battery cells. The battery cells located toward the center of this system consume active material first and begin to generate gas and/or degrade the electrolyte molecules while there remains sufficient voltage to drive shunt currents.

The inventors have realized that if all the battery cells of a flow battery system are fully discharged and de-energized more quickly, then a reduction of gas generation and degradation would occur. This can allow the system to be safe for interaction more quickly.

To discharge and de-energize the battery cells more quickly, the voltage of the electrolyte, which is typically about 50% of a stack voltage in a manifold, is pulled to the same voltage as an end cell on each end of the battery stack. The effect of this configuration can make the shunt currents nearly uniform across all cells within the battery stack. The control of making or breaking the connection of an electrode in the manifold to the end cell can include a switch that can be turned on or off during various operational modes of the battery stack and/or battery system.

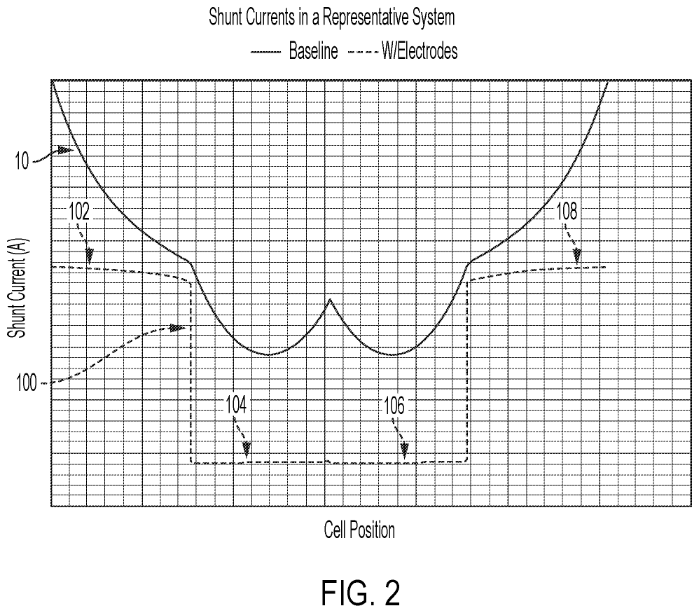

FIG. 2 illustrates a plot of shunt currents versus battery cell position in a conventional flow battery system 10 and a flow battery system 100 of the invention disclosed herein. With the flow battery system 100, electrodes (e.g. terminal plates) at ends of each of the battery stacks connect electrolytes in supply manifolds with the voltage of the end cells. This results in the intra-stack shunt current distribution becoming much more uniform, preventing the central cells from being over discharged. A quicker de-energization makes the system 100 safe for personnel interaction following a shut down, prevents prolonged heat generation, and maintains electrolyte health. As illustrated in FIG. 2, each stack (102, 104, 106, and 108) of the flow battery system 100 has a more uniform current than the conventional flow battery system 10.

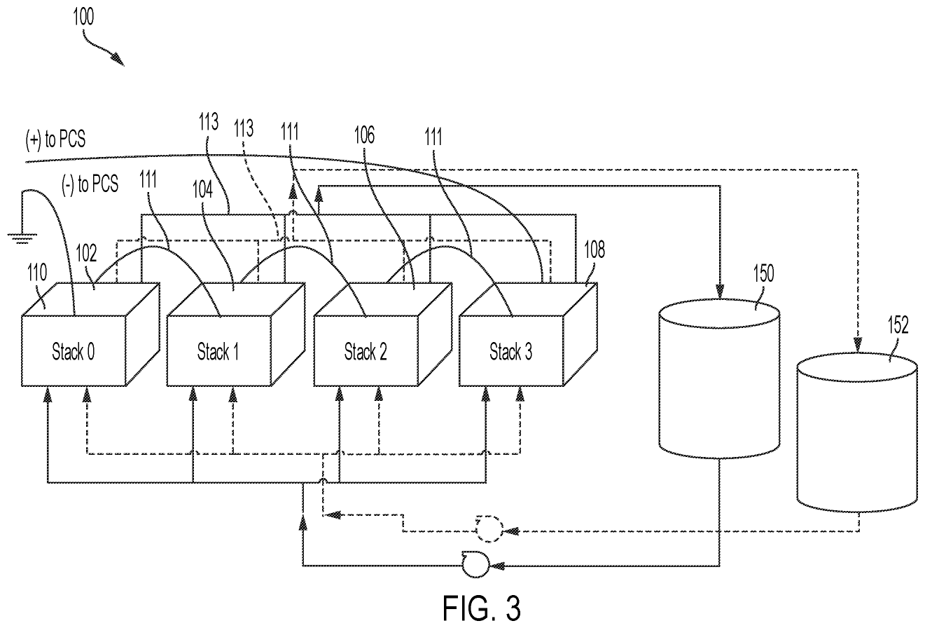

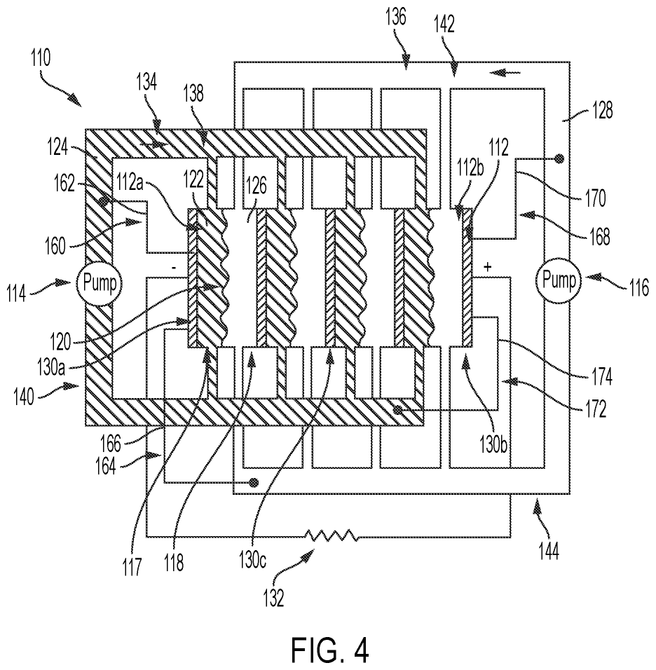

FIG. 3. illustrates a schematic of a flow battery system 100, and FIG. 4 illustrates a schematic of a flow battery stack 110 of the flow battery system 100, according to aspects of this disclosure. The flow battery system 100 can include a plurality of flow battery stacks 110. Each battery stack 110 can include a plurality of independent battery cells 112. In an aspect, each plurality of battery cells 112 in one battery stack 110 is configured substantially similarly to each of the plurality of battery cells 112 in each of the other battery stacks 110. In an aspect, each of the battery stacks 110 can be arranged in series by electrical connections 111. In an aspect, each of the electrolyte flows 113 for each of the battery stacks 110 can be arranged in parallel.

The aspects illustrated in FIGS. 3 and 4 show four battery stacks 110 and four battery cells 112. It will be appreciated that that the flow battery system 100 can include fewer or more battery stacks 110 and battery flow cells 112. The battery flow cells 112 are a type of rechargeable cell in which electrolyte containing one or more dissolved electroactive species flows through (into and out of) an electrochemical reactor that converts chemical energy to electricity. Additional electrolyte containing one or more dissolved electroactive species is stored externally, generally in tanks, and is usually pumped through the electrochemical reactor (or electrochemical reactors) by pumps 114 and 116. The flow cells 112 can have variable capacity depending on the size of the external storage tanks.

With reference to FIG. 4, each flow cell 112 can include an anode side 117 and a cathode side 118 separated by a separator 120 (e.g., an ion exchange membrane). The anode side 117 includes a negative flow channel 122 configured to receive a negative electrolyte 124. The cathode side 118 includes a positive flow channel 126 configured to receive a positive electrolyte 128. The separator 120 permits ionic flow between electroactive materials in the negative flow channel 122 and the positive flow channel 126.

The flow battery stack 110 further includes electrodes 130. The electrodes 130 can include a first electrode 130a, a second electrode 130b, and at least one bipolar electrode 130c. The electrodes 130 can serve as current collectors. The first electrode 130a is connected to the anode side 117 of a first cell 112a of the flow cells 112. The second electrode 130b is connected to the cathode side 118 of a second cell 112b of the flow cells 112. Each bipolar electrode 130c can be connected between adjacent flow cells 112 of the battery stack 110. In an alternative, each cell 112 can include a negative electrode and a positive electrode, whereby the negative electrode and the positive electrode of adjacent cells 112 are separated by a bipolar plate (not shown).

The negative and positive flow channels 122, 126, the first and second electrodes 130a, 130b, the at least one bipolar electrode 130c, and the separator 120 form electrochemical reactor that converts chemical energy to electricity (and, in certain arrangements, electricity to chemical energy). The first electrode 130a and the second electrode 130b can be electrically connected together by a load 132 to form an electrical circuit.

The flow battery stack 110 further includes a negative manifold 134 and a positive manifold 136. The negative manifold 134 is configured to provide the negative electrolyte 124 to the negative flow channel 122 of each cell 112. Similarly, the positive manifold 136 is configured to provide the positive electrolyte 128 to the positive flow channel 126 of each cell. The negative manifold 134 can be connected to the negative flow channel 122 of each battery cell 112 in parallel. In this configuration, the negative electrolyte 124 can be supplied to each negative flow channel 122 from a supply negative manifold portion 138, and the negative electrolyte 124 flows through each negative flow channel 122 to a receive negative manifold portion 140. The negative electrolyte 124 can be pumped through the negative manifold 134 and each negative flow channel 122 by the pump 114. It will be appreciated that an anode tank 150 can contain the negative electrolyte 124.

Similarly, the positive manifold 136 can be connected to the positive flow channel 126 of each battery cell 112 in parallel. In this configuration, the positive electrolyte 128 can be supplied to each positive flow channel 126 from a supply positive manifold portion 142, and the positive electrolyte 128 can flow through each positive flow channel 126 to a receive positive manifold portion 144. The positive electrolyte 128 can be pumped through the positive manifold 136 and each positive flow channel 126 by the pump 116. It will be appreciated that a cathode tank 152 can contain the positive electrolyte 128.

In an aspect, the manifolds 134, 136 can include flow directing structures to cause proper mixing of the electrolytes as they enter each respective flow channel 122, 126. Such flow directing structures may be configured to optimize the flow in each cell 112 within the flow battery stack 110 based upon the expected state of charge and other fluid properties within each cell 112.

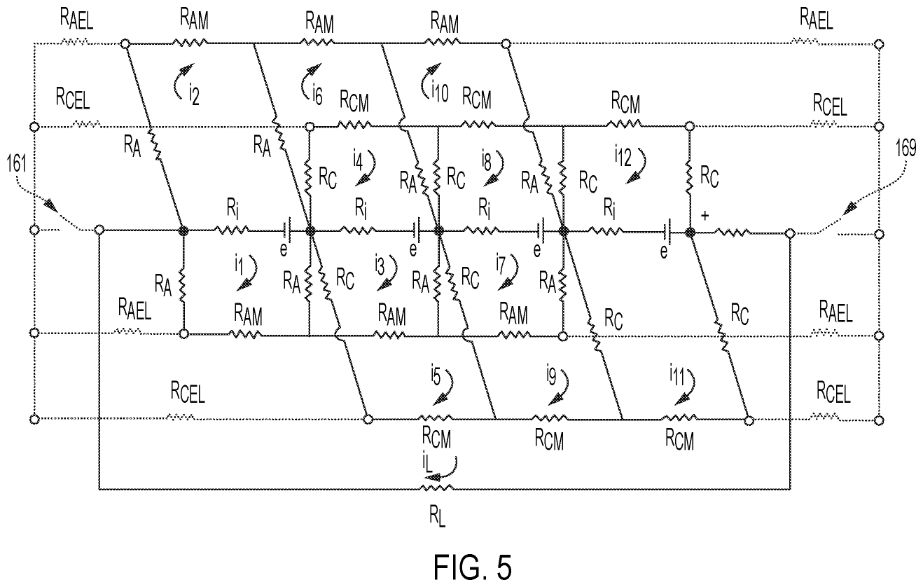

FIG. 5 illustrates a schematic of a circuit for the battery stack 110 shown in FIG. 4, according to an aspect of this disclosure. The various components are represented as follows: Rᵢ, cell internal resistance; e, ideal cell voltage (open circuit voltage); R_{A}, anodic feed and exit port resistance; R_{C}, cathodic feed and exit port resistance; R_{AM}, anode manifold segment resistance; R_{CM}, cathode manifold segment resistance; and R_{L}, system load resistance. The currents i₁ to i₁₂ represent the shunt loop currents and in the loop current for the load circuit. In this network, clockwise current flow was designated as the positive current direction.

Referring to FIGS. 4 and 5, the first electrode 130a is selectively connected between the negative flow channel 122 of a first cell 112a and the negative manifold 134 by a first electrical connection 160. In an aspect, the first electrical connection 160 can comprise a wired connection. The first electrical connection 160 can include a switch or contactor 161 that can control the selective connection of the first electrode 130a between a connect configuration and a disconnect configuration. In the connect configuration, the first electrode 130a is connected to the negative manifold 134 such that a first current 162 is free to flow between the first electrode 130a and the negative manifold 134. In the disconnect configuration, the first electrode 130a is disconnected from the negative manifold 134 such that the first current 162 is substantially prevented from flowing between the first electrode 130a and the negative manifold 134. The first electrical connection 160 can include a connection between the first electrode 130a and either or both of the supply negative manifold portion 138 and the receive negative manifold portion 140.

The first electrode 130a can further be selectively connected between the negative flow channel 122 of the first cell 112a and the positive manifold 136 by a second electrical connection 164. The second electrical connection 164 can comprise a wired connection. The second electrical connection 164 can include the switch 161. Alternatively, the second electrical connection 164 can include a different switch from the switch 161. The selective connection between the first electrode 130a and the positive manifold 136 can transition between a connect configuration and a disconnect configuration. In the connect configuration, the first electrode 130a is connected to the positive manifold 136 such that a second current 166 is free to flow between the first electrode 130a and the positive manifold 136. In the disconnect configuration, the first electrode 130a is disconnected from the negative manifold 134 such that the second current 166 is substantially prevented from flowing between the first electrode 130a and the positive manifold 136. The second electrical connection 164 can include a connection between the first electrode 130a and either or both of the supply positive manifold portion 142 and the receive positive manifold portion 144.

The second electrode 130b can be selectively connected between the positive flow channel 126 of a second cell 112b of the battery cells 112 and the positive manifold 136 by a third electrical connection 168. In an aspect, the cells 112 are arranged series (e.g. current flow between cells 112 is in series) from the first cell 112a to the second cell 112b. In an aspect, the third electrical connection 168 can comprise a wired connection. The third electrical connection 168 can include a switch or contactor 169 that can control the selective connection of the second electrode 130b between a connect configuration and a disconnect configuration. In the connect configuration, the second electrode 130b is connected to the positive manifold 136 such that a third current 170 is free to flow between the second electrode 130b and the positive manifold 136. In the disconnect configuration, the second electrode 130b is disconnected from the positive manifold 136 such that the third current 168 is substantially prevented from flowing between the second electrode 130b and the positive manifold 136. The third electrical connection 168 can include a connection between the second electrode 130b and either or both of the supply positive manifold portion 142 and the receive positive manifold portion 144.

The second electrode 130b can further be selectively connected between the positive flow channel 126 of the second cell 112b and the negative manifold 134 by a fourth electrical connection 172. The fourth electrical connection 172 can comprise a wired connection. The fourth electrical connection 172 can include the switch 169. Alternatively, the fourth electrical connection 172 can include a different switch from the switch 169. The selective connection between the second electrode 130b and the negative manifold 134 can transition between a connect configuration and a disconnect configuration. In the connect configuration, the second electrode 130b is connected to the negative manifold 134 such that a fourth current 174 is free to flow between the second electrode 130b and the negative manifold 134. In the disconnect configuration, the second electrode 130b is disconnected from the negative manifold 134 such that the fourth current 174 is substantially prevented from flowing between the second electrode 130b and the negative manifold 134. The fourth electrical connection 172 can include a connection between the first electrode 130b and either or both of the supply negative manifold portion 138 and the receive negative manifold portion 140.

The flow battery system 100 can be operated by controlling the pumps 114 and 116 to cause a negative electrolyte and a positive electrolyte to flow from tanks 150 and 152 through the negative and positive manifolds 134 and 136, respectively. As the electrolytes flow through the respective negative and positive flow channels 122 and 126 of each battery cell 112, an ion exchange occurs through each separator 120, and an electrical circuit is formed between each of the battery cells 112 and the load 132.

While the electrolytes are flowing through the negative and positive flow channels 122 and 126 of each battery cell 112, both switches 161 and 169 are in the disconnect configuration. In the disconnect configuration of switches 161 and 169, the first current 162 is substantially prevented from flowing between the first electrode 130a and the negative manifold 134, the second current 166 is substantially prevented from flowing between the first electrode 130a and the positive manifold 136, the third current 170 is substantially prevented from flowing between the second electrode 130b and the positive manifold 136, and the fourth current 174 is substantially prevented from flowing between the second electrode 130b and the negative manifold 134.

During a controlled power shutdown of the flow battery system 100, the flow of the negative electrolyte from the negative manifold 134 to the negative flow channel 122 of each battery cell 112 is ceased, and the flow of the positive electrolyte from the positive manifold 136 of each battery cell 112 is ceased. Either simultaneously with or after the controlled power shutdown, both the switches 161 and 169 can be operated to their respective connect configurations. In the connect configuration of switches 161 and 169, the first current 162 is free to flow between the first electrode 130a and the negative manifold 134, the second current 166 is free to flow between the first electrode 130a and the positive manifold 136, the third current 170 is free to flow between the second electrode 130b and the positive manifold 136, and the fourth current 174 is free to flow between the second electrode 130b and the negative manifold 134. The electrodes 130a and 130b at each end of the stacks 110 connect to the electrolytes in the manifolds 134 and 136 to the voltage of the end cells, thereby making the intra-stack shunt current distribution more uniform than a conventional battery system 10. The uniform current distribution prevents the central cells from being over discharged. Further, a quicker de-energization of each battery stack 110 makes the system safe for personnel interaction following a power shutdown, which can prevent prolonged heat generation and maintains electrolyte health. Adding electrodes to manipulate the shunt current distribution on demand can allow controlled power shutdowns without impacting efficiency. Flow battery system 100 allows the shunt currents to be altered without changing any internal feature of the battery cell 112, or battery stack 110.

The configuration of the flow battery system 100 can prolong the lifetime of the active electrolyte materials and improve safety of operating personnel during a shutdown. By transitioning the switches 161 and 169 to a connect configuration during a shutdown, degradation of expensive active material that is intended to last 20 years in operation can be prevented. If 0.037% of active material is lost at each shutdown, significant costs to replenish will be required over the course of the 20-year system life. Therefore, the system 100 can quickly de-energize and enable service personnel to complete PM and repairs faster, keeping system availability high.

It will be apparent to those of ordinary skill in the art that variations and alternative embodiments may be made given the foregoing description. Such variations and alternative embodiments are accordingly considered within the scope of the present invention.

Joinder references (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

### Embodiments

The following Embodiments are illustrative only and do not serve to limit the scope of the present disclosure or the appended claims.

Embodiment 1. A flow battery system, comprising: a plurality of cells, each of the plurality of cells including a positive flow channel configured to receive a positive electrolyte and a negative flow channel configured to receive a negative electrolyte, the plurality of cells being arranged in series from a first cell of the plurality of cells to a second cell of the plurality of cells; a positive manifold configured to supply the positive electrolyte to the positive flow channel; a negative manifold configured to supply the negative electrolyte to the negative flow channel; a first electrode connected between the negative flow channel of the first cell and a load, and wherein the first electrode is selectively connected between the negative flow channel of the first cell and the negative manifold, such that when the first electrode is connected to the negative manifold a current is free to flow between the first electrode and the negative manifold, and when the first electrode is disconnected from the negative manifold the current is substantially prevented from flowing between the first electrode and the negative manifold; and a second electrode connected between the positive flow channel of the second cell and the load.

Embodiment 2. The flow battery system of Embodiment 1, wherein the current is a first current, wherein the first electrode is further selectively connected between the negative flow channel of the first cell and the positive manifold, such that when the first electrode is connected to the negative manifold a second current is free to flow between the first electrode and the positive manifold, and when the first electrode is disconnected from the positive manifold the second current is substantially prevented from flowing between the first electrode and the positive manifold.

Embodiment 3. The flow battery system of Embodiment 2, wherein the second electrode is selectively connected between the positive flow channel of the second cell and the positive manifold, such that when the second electrode is connected to the positive manifold a third current is free to flow between the second electrode and the positive manifold, and when the second electrode is disconnected from the positive manifold the third current is substantially prevented from flowing between the second electrode and the positive manifold, and wherein the second electrode is further selectively connected between the positive flow channel of the second cell and the negative manifold, such that when the second electrode is connected to the negative manifold a fourth current is free to flow between the second electrode and the negative manifold, and when the second electrode is disconnected from the negative manifold the fourth current is substantially prevented from flowing between the second electrode and the negative manifold.

Embodiment 4. The flow battery system of Embodiment 2, wherein the selective connection between the first electrode and the negative manifold comprises a wired connection, and wherein the selective connection between the first electrode and the positive manifold comprises a wired connection, wherein the system further comprises a switch configured to control the selective connection between a connect configuration in which the first electrode is connected to both of the negative manifold and the positive manifold, and a disconnect configuration in which the first electrode is disconnected from both of the negative manifold and positive manifold.

Embodiment 5. The flow battery system of Embodiment 3, wherein the selective connection between the second electrode and the positive manifold comprises a wired connection, and wherein the selective connection between the second electrode and the negative manifold comprises a wired connection, wherein the system further comprises a switch configured to control the selective connection between a connect configuration in which the second electrode is connected to both of the positive manifold and the negative manifold, and a disconnect configuration in which the second electrode is disconnected from both of the positive manifold and the negative manifold.

Embodiment 6. The flow battery system of Embodiment 1, wherein each of the plurality of cells further includes an exchange membrane positioned between the positive and negative flow channels.

Embodiment 7. The flow battery system of Embodiment 1, wherein the first flow channel (which can be one of the positive flow channel or the negative flow channel) and the second flow channel (which can be the other of the positive flow channel or the negative flow channel) of each of the plurality of cells are arranged in parallel.

Embodiment 8. The flow battery system of Embodiment 1, wherein the plurality of cells is a first plurality of cells, the flow battery system further comprising: a first battery stack, wherein the first battery stack comprises the first plurality of cells; and a second battery stack comprising a second plurality of cells, wherein the second plurality of cells is configured substantially similarly as the first plurality of cells.

Embodiment 9. The flow battery system of Embodiment 8, wherein the first battery stack and the second battery stack are arranged in series, and wherein the positive and negative flow channels of each of the first plurality of cells are arranged in parallel with the positive and negative flow channels of each of the second plurality of cells.

Embodiment 10. A method for operating a flow battery system, the flow battery system including a plurality of cells that each have a positive flow channel for receiving a positive electrolyte and a negative flow channel for receiving a negative electrolyte, the plurality of cells being arranged in series from a first cell of the plurality of cells to a second cell of the plurality of cells, the method comprising: ceasing a flow of the negative electrolyte from a negative manifold to the negative flow channel; ceasing a flow of the positive electrolyte from a positive manifold to the positive flow channel; and connecting a first electrode between the negative flow channel of the first cell and the negative manifold such that a current is free to flow between the first electrode and the negative manifold, wherein the first electrode is connected between the negative flow channel of the first cell and a load, and wherein a second electrode is connected between the positive flow channel of the second cell and the load.

Embodiment 11. The method of Embodiment 10, wherein the current is a first current, the method further comprising: connecting the first electrode between the negative flow channel of the first cell and the positive manifold such that a second current is free to flow between the first electrode and the positive manifold.

Embodiment 12. The method of Embodiment 11, further comprising: connecting the second electrode between the positive flow channel of the second cell and the positive manifold such that a third current is free to flow between the second electrode and the positive manifold; and connecting the second electrode between the positive flow channel of the second cell and the negative manifold such that a fourth current is free to flow between the second electrode and the negative manifold.

Embodiment 13. The method of Embodiment 12, further comprising: causing the flow of the negative electrolyte from a negative manifold to the negative flow channel; causing the flow of the positive electrolyte from a positive manifold to the positive flow channel; and either simultaneously with or after causing the flow of the negative and positive electrolytes, dis-connecting the first electrode from the negative manifold such that the first current is substantially prevented from flowing between the first electrode and the negative manifold.

Embodiment 14. The method of Embodiment 13, further comprising: either simultaneously with or after causing the flow the negative and positive electrolytes, dis-connecting the first electrode from the positive manifold such that the second current is substantially prevented from flowing between the first electrode and the positive manifold; dis-connecting the second electrode from the positive manifold such that the third current is substantially prevented from flowing between the second electrode and the positive manifold; and dis-connecting the second electrode from the negative manifold such that the fourth current is substantially prevented from flowing between the second electrode and the negative manifold.

Embodiment 15. The method of Embodiment 10, wherein the step of connecting the first electrode occurs either simultaneously with or after ceasing the flow of the negative and positive electrolytes.

Embodiment 16. A flow battery system comprising: a plurality of cells, each of the plurality of cells including a positive flow channel for receiving a positive electrolyte and a negative flow channel for receiving a negative electrolyte, the plurality of cells being arranged in series from a first cell of the plurality of cells to a second cell of the plurality of cells; a positive manifold configured to supply the positive electrolyte to the positive flow channel; a negative manifold configured to supply the negative electrolyte to the negative flow channel; a first electrode connected between the negative flow channel of the first cell and a load, wherein the first electrode is selectively connected between the negative flow channel of the first cell and the negative manifold, and wherein the first electrode is further selectively connected between the negative flow channel of the first cell and the positive manifold; and a second electrode connected between the positive flow channel of the second cell and the load, wherein the second electrode is selectively connected between the positive flow channel of the second cell and the positive manifold, and wherein the second electrode is further selectively connected between the positive flow channel of the second cell and the negative manifold.

Embodiment 17. The flow battery system of Embodiment 16, further comprising:
a first switch configured to control the selective connections of the first electrode between a first connect configuration in which the first electrode is connected to both of the negative manifold and the positive manifold, and a first disconnect configuration in which the first electrode is disconnected from both of the negative manifold and positive manifold; and a second switch configured to control the selective connections of the second electrode between a connect configuration in which the second electrode is connected to both of the positive manifold and the negative manifold, and a disconnect configuration in which the second electrode is disconnected from both of the positive manifold and the negative manifold.

What is claimed:

1. A flow battery system, comprising:
a plurality of cells, each of the plurality of cells including a positive flow channel configured to receive a positive electrolyte and a negative flow channel configured to receive a negative electrolyte, the plurality of cells being arranged in series from a first cell of the plurality of cells to a second cell of the plurality of cells;
a positive manifold configured to supply the positive electrolyte to the positive flow channel;
a negative manifold configured to supply the negative electrolyte to the negative flow channel;
a first electrode connected between the negative flow channel of the first cell and a load, and wherein the first electrode is selectively connected between the negative flow channel of the first cell and the negative manifold, such that when the first electrode is connected to the negative manifold a current is free to flow between the first electrode and the negative manifold, and when the first electrode is disconnected from the negative manifold the current is substantially prevented from flowing between the first electrode and the negative manifold; and
a second electrode connected between the positive flow channel of the second cell and the load.

2. The flow battery system of claim 1, wherein the current is a first current, wherein the first electrode is further selectively connected between the negative flow channel of the first cell and the positive manifold, such that when the first electrode is connected to the negative manifold a second current is free to flow between the first electrode and the positive manifold, and when the first electrode is disconnected from the positive manifold the second current is substantially prevented from flowing between the first electrode and the positive manifold.

3. The flow battery system of claim 2, wherein the second electrode is selectively connected between the positive flow channel of the second cell and the positive manifold, such that when the second electrode is connected to the positive manifold a third current is free to flow between the second electrode and the positive manifold, and when the second electrode is disconnected from the positive manifold the third current is substantially prevented from flowing between the second electrode and the positive manifold, and
wherein the second electrode is further selectively connected between the positive flow channel of the second cell and the negative manifold, such that when the second electrode is connected to the negative manifold a fourth current is free to flow between the second electrode and the negative manifold, and when the second electrode is disconnected from the negative manifold the fourth current is substantially prevented from flowing between the second electrode and the negative manifold.

4. The flow battery system of claim 2, wherein the selective connection between the first electrode and the negative manifold comprises a wired connection, and wherein the selective connection between the first electrode and the positive manifold comprises a wired connection, wherein the system further comprises a switch configured to control the selective connection between a connect configuration in which the first electrode is connected to both of the negative manifold and the positive manifold, and a disconnect configuration in which the first electrode is disconnected from both of the negative manifold and positive manifold.

5. The flow battery system of claim 3, wherein the selective connection between the second electrode and the positive manifold comprises a wired connection, and wherein the selective connection between the second electrode and the negative manifold comprises a wired connection, wherein the system further comprises a switch configured to control the selective connection between a connect configuration in which the second electrode is connected to both of the positive manifold and the negative manifold, and a disconnect configuration in which the second electrode is disconnected from both of the positive manifold and the negative manifold.

6. The flow battery system of claim 1, wherein each of the plurality of cells further includes an exchange membrane positioned between the positive and negative flow channels.

7. The flow battery system of claim 1, wherein the first flow channel and the second flow channel of each of the plurality of cells are arranged in parallel.

8. The flow battery system of claim 1, wherein the plurality of cells is a first plurality of cells, the flow battery system further comprising:
a first battery stack, wherein the first battery stack comprises the first plurality of cells; and
a second battery stack comprising a second plurality of cells, wherein the second plurality of cells is configured substantially similarly as the first plurality of cells.

9. The flow battery system of claim 8, wherein the first battery stack and the second battery stack are arranged in series, and wherein the positive and negative flow channels of each of the first plurality of cells are arranged in parallel with the positive and negative flow channels of each of the second plurality of cells.

10. A method for operating a flow battery system, the flow battery system including a plurality of cells that each have a positive flow channel for receiving a positive electrolyte and a negative flow channel for receiving a negative electrolyte, the plurality of cells being arranged in series from a first cell of the plurality of cells to a second cell of the plurality of cells, the method comprising:
ceasing a flow of the negative electrolyte from a negative manifold to the negative flow channel;
ceasing a flow of the positive electrolyte from a positive manifold to the positive flow channel; and
connecting a first electrode between the negative flow channel of the first cell and the negative manifold such that a current is free to flow between the first electrode and the negative manifold, wherein the first electrode is connected between the negative flow channel of the first cell and a load, and wherein a second electrode is connected between the positive flow channel of the second cell and the load.

11. The method of claim 10, wherein the current is a first current, the method further comprising:
connecting the first electrode between the negative flow channel of the first cell and the positive manifold such that a second current is free to flow between the first electrode and the positive manifold.

12. The method of claim 11, further comprising:
connecting the second electrode between the positive flow channel of the second cell and the positive manifold such that a third current is free to flow between the second electrode and the positive manifold; and
connecting the second electrode between the positive flow channel of the second cell and the negative manifold such that a fourth current is free to flow between the second electrode and the negative manifold.

13. The method of claim 12, further comprising:
causing the flow of the negative electrolyte from a negative manifold to the negative flow channel;
causing the flow of the positive electrolyte from a positive manifold to the positive flow channel; and
either simultaneously with or after causing the flow of the negative and positive electrolytes, dis-connecting the first electrode from the negative manifold such that the first current is substantially prevented from flowing between the first electrode and the negative manifold.

14. The method of claim 13, further comprising:
either simultaneously with or after causing the flow the negative and positive electrolytes,
dis-connecting the first electrode from the positive manifold such that the second current is substantially prevented from flowing between the first electrode and the positive manifold;
dis-connecting the second electrode from the positive manifold such that the third current is substantially prevented from flowing between the second electrode and the positive manifold; and
dis-connecting the second electrode from the negative manifold such that the fourth current is substantially prevented from flowing between the second electrode and the negative manifold.

15. The method of claim 10, wherein the step of connecting the first electrode occurs either simultaneously with or after ceasing the flow of the negative and positive electrolytes.

16. A flow battery system comprising:
a plurality of cells, each of the plurality of cells including a positive flow channel for receiving a positive electrolyte and a negative flow channel for receiving a negative electrolyte, the plurality of cells being arranged in series from a first cell of the plurality of cells to a second cell of the plurality of cells;
a positive manifold configured to supply the positive electrolyte to the positive flow channel;
a negative manifold configured to supply the negative electrolyte to the negative flow channel;
a first electrode connected between the negative flow channel of the first cell and a load, wherein the first electrode is selectively connected between the negative flow channel of the first cell and the negative manifold, and wherein the first electrode is further selectively connected between the negative flow channel of the first cell and the positive manifold; and
a second electrode connected between the positive flow channel of the second cell and the load, wherein the second electrode is selectively connected between the positive flow channel of the second cell and the positive manifold, and wherein the second electrode is further selectively connected between the positive flow channel of the second cell and the negative manifold.

17. The flow battery system of claim 16, further comprising:
a first switch configured to control the selective connections of the first electrode between a first connect configuration in which the first electrode is connected to both of the negative manifold and the positive manifold, and a first disconnect configuration in which the first electrode is disconnected from both of the negative manifold and positive manifold; and
a second switch configured to control the selective connections of the second electrode between a connect configuration in which the second electrode is connected to both of the positive manifold and the negative manifold, and a disconnect configuration in which the second electrode is disconnected from both of the positive manifold and the negative manifold.
